(19) United States
(12) Patent Application Publication
(10) Pub. No.: US 2015/0121373 A1
(43) Pub. Date: Apr. 30, 2015

(54) User Privacy Systems And Methods

(71) Applicant: Alistair Black, Los Gatos, CA (US)

(72) Inventor: Alistair Black, Los Gatos, CA (US)

(21) Appl. No.: 14/469,450

(22) Filed: Aug. 26, 2014

Related U.S. Application Data
(63) Continuation-in-part of application No. 14/067,775, filed on Oct. 30, 2013.

(51) Int. Cl. G06F 9/455

(52) U.S. Cl. CPC G06F 9/45533
USPC 718/1

(57) ABSTRACT

Example processing systems and methods are described. In one implementation, a method receives a request from a user to access a website and perform an action related to the website. The method identifies multiple alias definitions associated with the user, where each alias definition describes at least one action related to at least one website. A particular alias definition is selected based on the action and the website. A virtual machine is invoked to perform the action on behalf of the user based on alias information contained in the selected alias definition.

### CROSS REFERENCE TO RELATED APPLICATIONS

This application is a Continuation-in-Part of U.S. application Ser. No. 14/067,775, filed Oct. 30, 2013, which is hereby incorporated herein by reference in its entirety.

### TECHNICAL FIELD

The present disclosure relates to application processing systems and methods that execute one or more programming languages to perform a variety of processing tasks.

### BACKGROUND

Various types of processing systems perform multiple tasks associated with a particular processing operation. For example, processors and computing systems perform various tasks to implement application programs. During execution, application programs perform many tasks and operations that may include interactions with multiple systems and components. As these tasks and operations become more numerous or more complex, the application program that performs the tasks and operations also becomes more complex. Certain modifications to the application program (e.g., the addition of more tasks and operations) further increases the complexity of executing the application program. The management and execution of these application programs can be difficult and time consuming.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram depicting an embodiment of a VMBot (virtual machine bot) or virtual machine (VM).

FIG. 3 is a block diagram depicting an embodiment of an application management system.

FIG. 4 is a flow diagram depicting an embodiment of a method for assigning application program tasks to individual VMBots.

FIG. 5 is a flow diagram depicting an embodiment of a method for managing the application program tasks assigned to the individual VMBots.

FIG. 6 is a block diagram depicting an embodiment of a system for processing application program tasks.

FIG. 7 is a block diagram depicting an embodiment of a VMBot library.

FIG. 8 depicts an example operational plan.

FIG. 9 is a block diagram depicting an environment within which an example embodiment may be implemented.

FIG. 10 is a block diagram depicting an embodiment of an alias management system.

FIG. 11 is a flow diagram depicting an embodiment of a method for creating alias definitions for a user.

FIG. 12 is a flow diagram depicting an embodiment of a method for managing performance of user activities with VMBot aliases.

FIG. 13 depicts an example alias definition.

FIG. 14 is a block diagram depicting an example computing device.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein manage and perform various tasks associated with an application program. In the described embodiments, these tasks are performed by virtual machines configured with specific software to form what is referred to herein as a “VMBot” (a virtual machine bot). A virtual machine (VM) refers to a computing system (or computing environment) that is created inside another computing system using software. Although the VM is contained inside another computing system as a software program, the VM operates like an independent computing system as far as the user or the outside world is concerned. The systems and methods described herein use these VMs as a container for software programs and applications, as discussed below. Together these software components and the VM form a “VMBot.” Many of these VMBots may be used together to solve a specific processing problem as discussed in the examples herein. In particular implementations, the number of VMBots used to perform a specific processing operation range from a few VMBots to billions of VMBots.

Throughout this written description, the terms “virtual machine”, “VM,” and “VMBot” may be used interchangeably. When referring to a “VM,” this written description is emphasizing the VM container, but assumes that there is some VMBot definition contained inside the VM thereby making the VM referred to an actual VMBot. However, for simplicity, this machine may still be referred to simply as a VM. In some embodiments, each VM or VMBot is capable of performing a specific task. To implement a particular application program tasks, any number of VMs or VMBots are implemented to perform all of the application program tasks associated with an application program. Although specific examples herein refer to VMBots or VMs, alternate embodiments may use any type of mechanism or system to perform the application program tasks.

The systems and methods described herein provide a flexible approach to processing tasks associated with an application program. In a particular embodiment, a request is received to execute an application program. The described systems and methods identify multiple tasks associated with the application program and invoke multiple virtual machines to perform the multiple tasks associated with the application program. Each of the multiple tasks is assigned to a particular virtual machine for processing. Task results are received from the multiple virtual machines and compiled into a single application program result.

In particular embodiments, the VMBot has several advantages in large scale computing operations. For example, the independence of the VMBots allows operations to proceed without interfering with each other. This makes bugs in the software easier to find and less damaging to the overall system operation, and allows for more complex pieces of VMBots to be created and used. Additionally, VMBots have a higher computing reliability due to the existing systems that allow VM-based systems to operate in fail-over or High Availability environments as well as the fact that VMBot independence also increases reliability of the systems. Further, VMBots are easy to clone, wake up, put to sleep, and control. This allows fast assembly of a processing set of VMBots by simply choosing the required VMBot types from a pool of definitions and cloning each type of VMBot the number of times needed to accomplish the appropriate tasks.

VMBots are also advantageous since data management, data storage, and data sharing methods already exist for VMs and thus also for VMBots. Further communication between VMBots and between a VMBot and management applications can be performed using standard protocols such as HTTP, HTTPS, FTP, and the like. A VMBot is an efficient way to scale a computing system large enough to attack problems such as system modeling, application program execution, and the like. Additionally, the cost of implementing systems using VMBots is very low. Utilizing modern computing servers, hundreds of VMBots may be implemented with a single low-cost server. Using multiplexing methods as described herein, the number of VMBots can be increased to thousands per low cost server. The VMBot platform may be thought of as a new computing and data communication platform where, like computers on the Internet or cells in the human body, VMBots can communicate with each other anywhere, and also cooperate, exchange information, and coordinate work since they are also controlled and assigned tasks from a central planning/management application. So, a computing platform made of VMBots can have millions or billions of operations occurring over the entire globe, while being coordinated centrally or in a distributed peer-to-peer fashion. In this implementation, each node is able to communicate and exchange data with every other node using standard low-cost protocols. VMBot types can be created by many different developers globally and can be changed in real time, all for the purpose of solving problems that are data and compute intensive, and that were previously intractable. All of this can be managed and executed from a single software program. Finally, a VMBot can be embedded in a physical robot, such as a robot designed for industrial or service applications, thereby allowing the physical robot to cooperate and interact with the “virtual” VMBots operated on the Internet or other data communication platform.

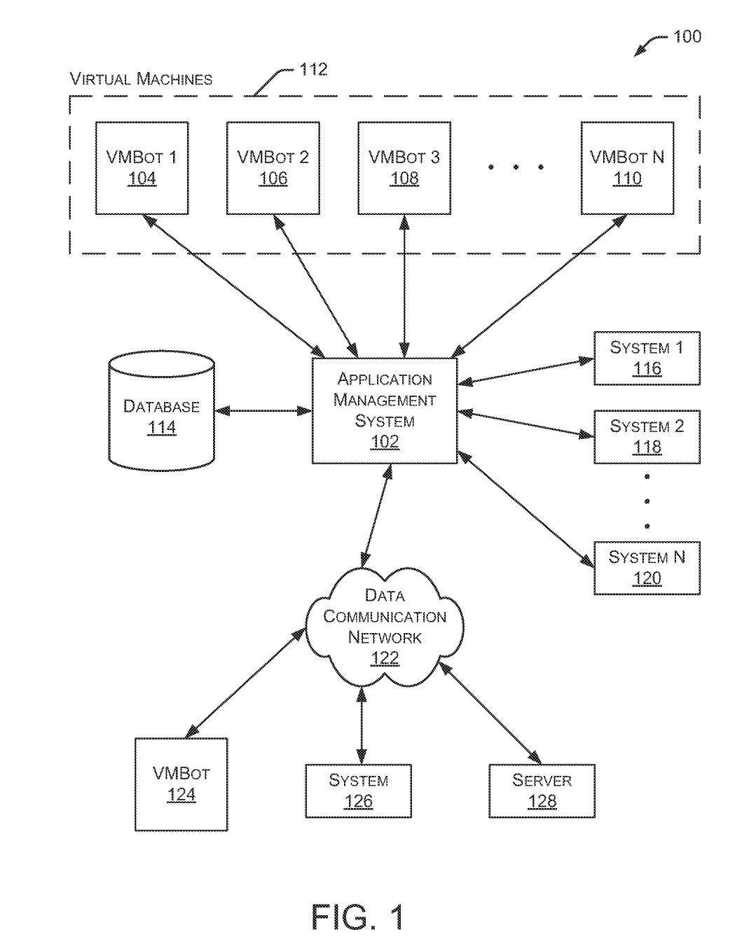

FIG. 1 is a block diagram depicting an environment 100 within which an example embodiment may be implemented. Environment 100 includes an application management system 102 coupled to multiple VMBots 104, 106, 108, and 110. Collectively, VMBots 104-110 may be referred to as VMs 112. VMs 112 may also be referred to as a “pool of VMs,” a “pool of VMBots” or a “resource pool.” A particular pool of VMs (or VMBots) may contain any number of VMs (or VMBots). Each VMBot 104-110 performs a particular task or function, such as a task within a larger, more complex, processing operation. In some embodiments, the specific task performed by each VMBot 104-110 is limited to prevent the VMBot from interfering with other tasks within a processing operation, or interfering with other processing operations.

Application management system 102 manages the execution of multiple VMBots 104-110 to implement an application program. A database 114 is coupled to application management system 102 and stores various information used by the application management system, such as VMBot information, process operation data, application program instructions, and the like. Multiple systems 116, 118, and 120 are coupled to application management system 102. These systems 116, 118, and 120 may communicate, for example, requests to implement application programs (or portions of application programs) to application management system 102, which then invokes multiple VMBots 104-110 to perform the requested tasks or operations. Upon completion of the tasks or operations, application management system 102 communicates the results of the requested tasks or operations to the requesting system 116, 118 or 120.

Application management system 102 is coupled to a data communication network 122, such as the Internet. Data communication network 122 may utilize any communication protocol and any type of communication medium. In some embodiments, data communication network 122 is a combination of two or more networks coupled to one another. Application management system 102 communicates with other VMBots 124, systems 126, and servers 128 through data communication network 122. Thus, application management system 102 can distribute tasks to any VMBot 124 accessible via data communication network 122. Additionally, application management system 102 can receive requests from any system 126 or server 128 coupled to data communication network 122.

In some embodiments application management system 102 is distributed between the VMBots 104-110 and the tasks shared resulting in a peer-to-peer connection of the VMBots. This kind of system has the advantage of no central application management system, making the system less susceptible to certain security risks. However, this may increase the complexity of the VMBots themselves and may require more communication between the VMBots.

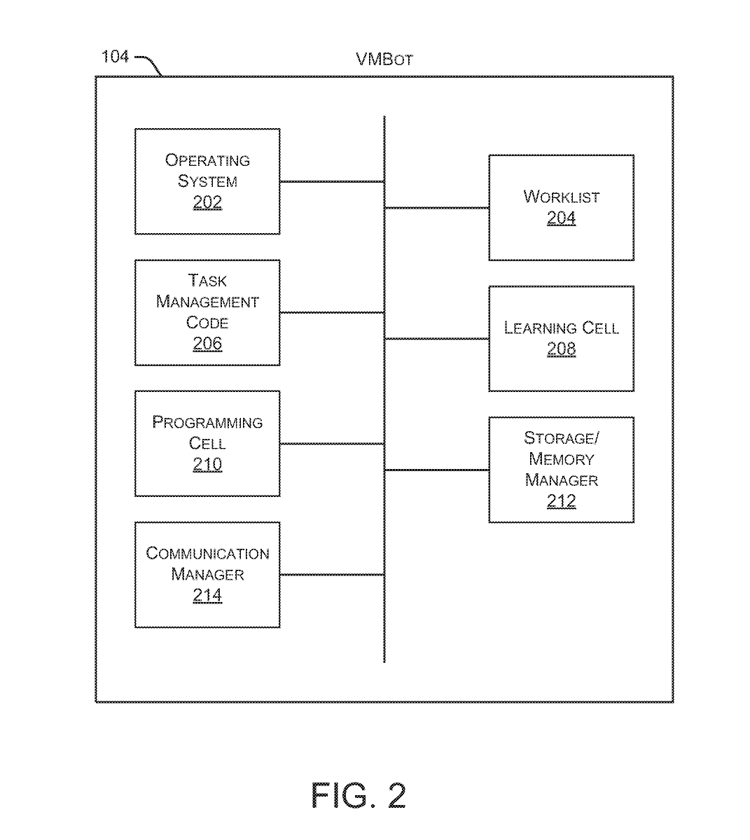

FIG. 2 is a block diagram depicting an embodiment of VMBot 104. As shown in FIG. 2, VMBot 104 includes an operating system 202 that manages the operation of the VMBot, a worklist 204, and task management code 206. As discussed herein, worklist 204 may be executed by VMBot 104 at the direction of application management system 102. Worklist 204 is a set of tasks that need to be performed when executing a particular application program. VMBot 104 may be responsible for a particular task within worklist 204. Example worklist tasks include: get data from website, push data to a system/device, calculate sales tax, initiate a purchase, and the like. Task management code 206 manages the execution of tasks in worklist 204 by VMBot 104. Task management code 206 is also capable of managing certain security aspects of the system such as limiting access to particular websites or restricting tasks that can be performed by VMBot 104.

VMBot 104 also includes a learning cell 208, which includes, for example, a set of tables that define a set of tasks for VMBot 104 based on a set of conditions (and/or rules) and “learned” behavior obtained from a training sequence or based on environmental feedback. A programming cell 210 is related to learning cell 208 and contains fixed programming behaviors based on the environment in which VMBot 104 is located. Programming cell 210 includes a set of relationships maintained in tables (or other data structures) that specify the behavior of VMBot 104 based on the current inputs (e.g., the current application processing operation). The tables within programming cell 210 may be changed by a training or learning process. A storage/memory manager 212 manages the storage and retrieval of data from a storage device, memory device, and the like. A communication manager 214 manages the communication of data between VMBot 104 and other VMBots, systems, and devices.

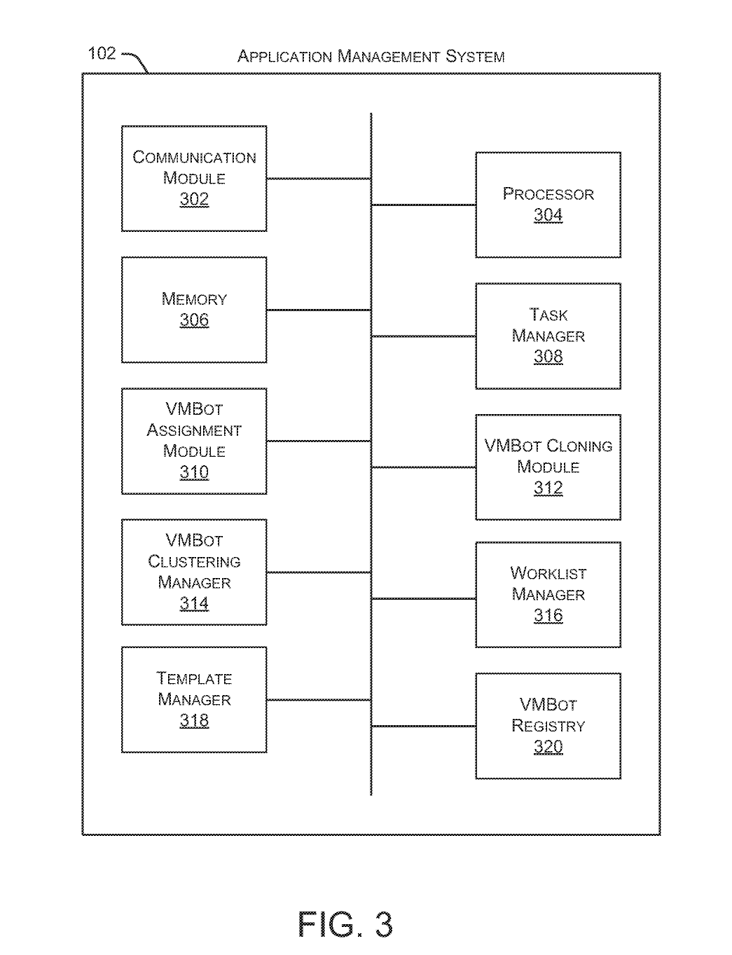

FIG. 3 is a block diagram depicting an embodiment of application management system 102. As shown in FIG. 3, application management system 102 includes a communication module 302, a processor 304, and a memory 306. Communication module 302 allows application management system 102 to communicate with other systems, such as VMBots 104-110, database 114, systems 116-120, VMBot 124, system 126, server 128, and the like. Processor 304 executes various instructions to implement the functionality provided by application management system 102. Memory 306 stores these instructions as well as other data used by processor 304 and other modules contained in application management system 102.

Additionally, application management system 102 includes a task manager 308 that manages any number of tasks being performed by any number of VMBots and other systems and devices. A VMBot assignment module 310 assigns tasks to appropriate VMBots for execution by the assigned VMBot. A VMBot cloning module 312 creates a new instance of a VMBot by cloning an existing VMBot. VMBot cloning module 312 is capable of quickly creating a complete copy of an existing VMBot and deploying the newly created VMBot to perform a specific task. VMBot cloning module 312 also deletes instances of VMBots when they are no longer necessary (e.g., after the VMBot has completed its assigned task).

A VMBot clustering manager 314 in application management system 102 handles the clustering of multiple VMBots. Clustering of multiple VMBots allows a specific number of VMBots who share the cluster to communicate with decreased latency and larger transfer rates. For example, a set of VMBots are clustered if they need to share data or communicate together more efficiently than is normally the case for communication between VMBots. In some cases, the processing requirements require VMBots to share data efficiently, while in other cases VMBots need to be geographically distributed and thus are not clustered.

A worklist manager 316 manages worklists associated with one or more application program tasks or operations. As mentioned herein, a worklist is a set of tasks that need to be performed for a particular process. In some embodiments, multiple VMBots are each responsible for a particular task within the worklist. Worklist manager 316 manages the assignment of these tasks to VMBots, and manages the performance of the task by the assigned VMBot. A template manager 318 handles the use of various templates to perform certain processing operations. A template defines how one or more VMBots interacts with other VMBots, other systems, and the like. A VMBot registry 320 maintains information about multiple VMBots, such as the task that a particular VMBot can perform, a process to which the VMBot is currently assigned, VMBots currently available for assignment, and the like.

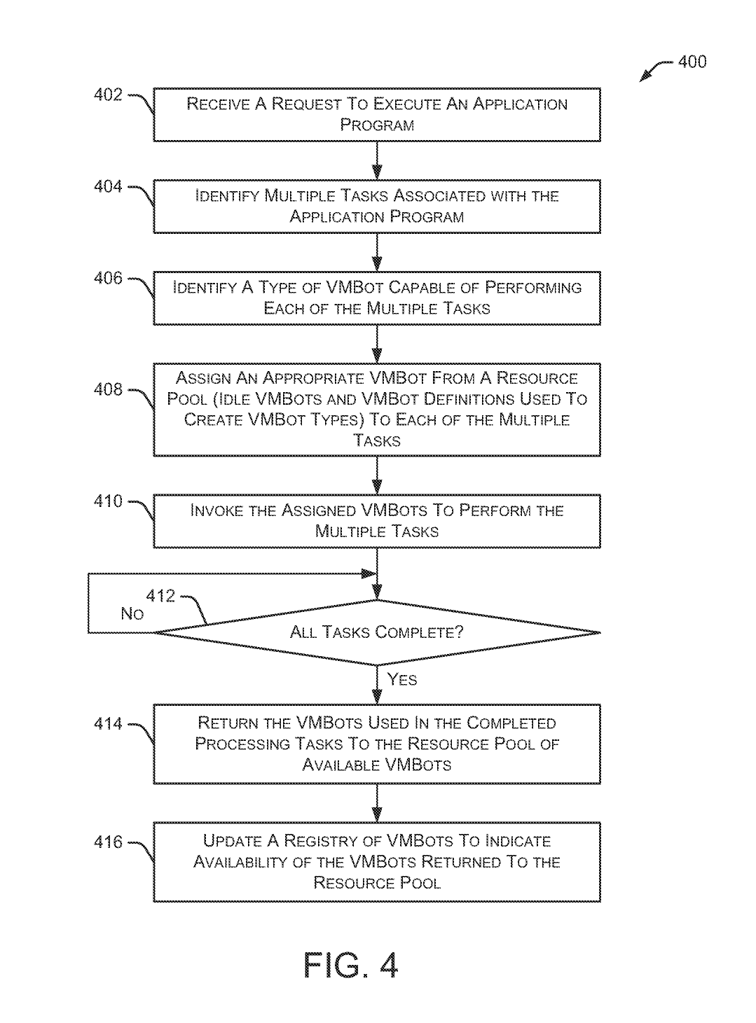

FIG. 4 is a flow diagram depicting an embodiment of a method 400 for assigning application program tasks to individual VMBots. Method 400 is implemented, for example, within environment 100 shown in FIG. 1. Initially, method 400 receives a request to execute an application program at 402 and identifies multiple tasks associated with the application program at 404. For each of the multiple tasks associated with the application program, method 400 identifies a type of VMBot capable of performing the task at 406. An appropriate VMBot is assigned from a resource pool to each of the multiple tasks associated with the application program at 408. The resource pool may include idle VMBots and VMBot definitions used to create VMBot types. For example, a VMBot definition is used to create a specific type of VMBot (i.e., cloning a VMBot) to perform a particular task. As discussed herein, an example of a VMBot may be thought of as a “programming thread” in a computer system. For example, a specific VMBot performs one or more tasks associated with a programming thread associated with an application program. Once the VMBot is launched, it can run independently and only report back when it finds relevant data or completes its assigned task. Essentially, the VMBot is running as a separate process thread along with numerous other VMBots running different process threads simultaneously. In particular embodiments, the resource pool includes memory, storage, and processing components used to create VMBots and VMs. The VMBot definitions are used to create VMBots from the VMs that are created. The resource pool may also include idle VMBots that are not currently being used.

After assigning the VMBots at 408, the multiple assigned VMBots are invoked to perform the multiple tasks at 410. In some embodiments, the multiple assigned VMBots are invoked simultaneously (or substantially simultaneously). In other embodiments, the VMBots are invoked over a period of time, or invoked when needed (e.g., when a preceding task is completed, it may trigger invoking of another task that relies on the results of the preceding task). Method 400 monitors the VMBot and/or processing task to determine when all processing tasks are complete at 412. When all processing tasks are complete, the VMBots used in the completed processing tasks are returned to the resource pool of available VMBots at 414. Method 400 then updates a registry of VMBots to indicate the availability of the VMBots that were just returned to the resource pool at 416.

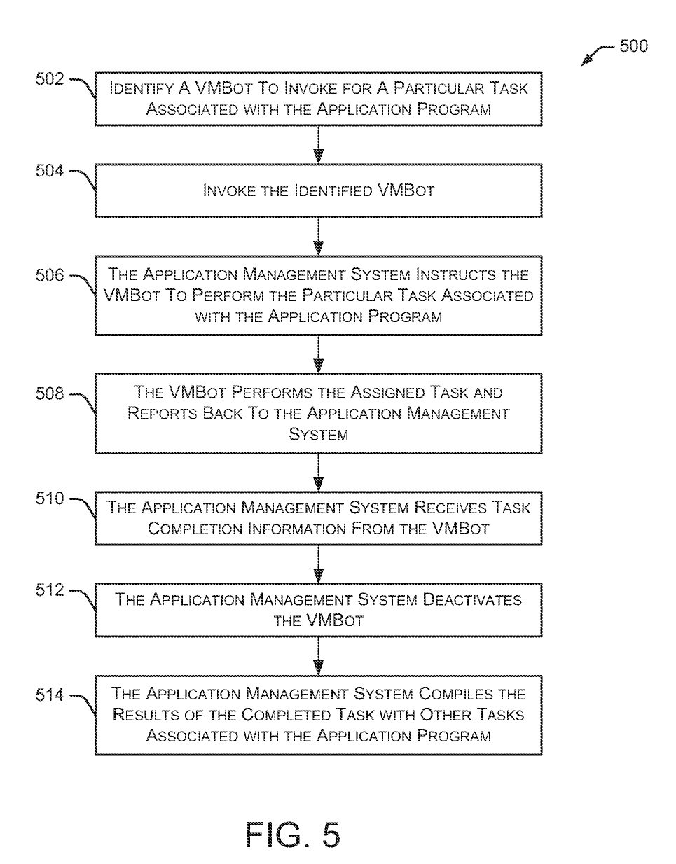

FIG. 5 is a flow diagram depicting an embodiment of a method 500 for managing the application program tasks assigned to the individual VMBots. Method 500 is implemented, for example, within environment 100 shown in FIG. 1. Initially, method 500 identifies a VMBot to invoke at 502 for a particular task associated with the application program. The identified VMBot is then invoked at 504. The application management system instructs the VMBot to perform the particular task associated with the application program at 506. The identified VMBot performs the assigned task and reports back to the application management system at 508 (e.g., reporting completion of the assigned task). The application management system receives the task completion information from the VMBot at 510 and deactivates the VMBot at 512. When deactivating the VMBot, the application management system may keep the VMBot in the resource pool in an idle state, or may delete the VMBot. If the VMBot is deleted, the application management system can create a new instance of the VMBot in the future based on the associated VMBot definition. Finally, the application management system compiles the results of the completed task with other tasks associated with the application program.

By executing each task associated with the application program as a separate VMBot, the multiple tasks do not interfere with one another. Additionally, each VMBot can be limited to accessing only the data or resources needed to complete the assigned task. This approach improves security since a particular instance of a VMBot will not be exposed to data or resources that are not necessary to complete the assigned task. Additionally, this approach limits the ability of malicious algorithms to infect a processing task by attempting to force the VMBot to perform an unapproved activity.

The multiple VMBots can each operate (e.g., perform tasks) independently of the other VMBots. Thus, if one VMBot experiences problems performing its assigned task, it does not affect the other VMBots, which continue normal operation.

In a particular embodiment, many VMBots are stored as snap shots on a storage device (such as a disk drive) and referred to as “VM snaps.” In alternate embodiments, the VMBots may be stored in system cache memory or any other memory/storage mechanism. The VM snaps do not use any system resources (other than disk and/or memory storage) until they are invoked by the system. Each of these VM snaps can have security enhancements (e.g., limited resource access and maintenance of data for specific systems) such that the VM snap is only used for a specific system and for specific tasks. Thus, the VM snaps are “personalized” to the specific system. This approach is advantageous because there are defined VMBots ready to load for many different uses. Additionally, VMBots with jobs that are long-lived but not always processing can efficiently sleep and release resources when they are not busy, yet still be able to wake up and continue the same process as when it went to sleep. In this situation, a large number of VM snaps are stored on the disk storage, but only a few are invoked at any particular time. Thus, the multiple VM snaps are “multiplexed” such that a specific VM data set is only invoked at a specific time and circumstance that it is needed. This results in an efficient usage of system resources since the VM snaps do not require any system resources until they are invoked. After the VM snaps are deactivated, the previously used system resources are released and made available for other processes.

In a particular implementation, execution of an application program requires the processing of a significant number of tasks. In this situation, many VMBots are invoked (e.g., thousands, tens of thousands, millions or billions of VMBots) to handle the various tasks. Each VMBot may perform one or more of the multiple tasks. Since many VMBots are invoked substantially simultaneously, the processing tasks are completed significantly faster than a single VMBot or other system performing the tasks in a sequential manner.

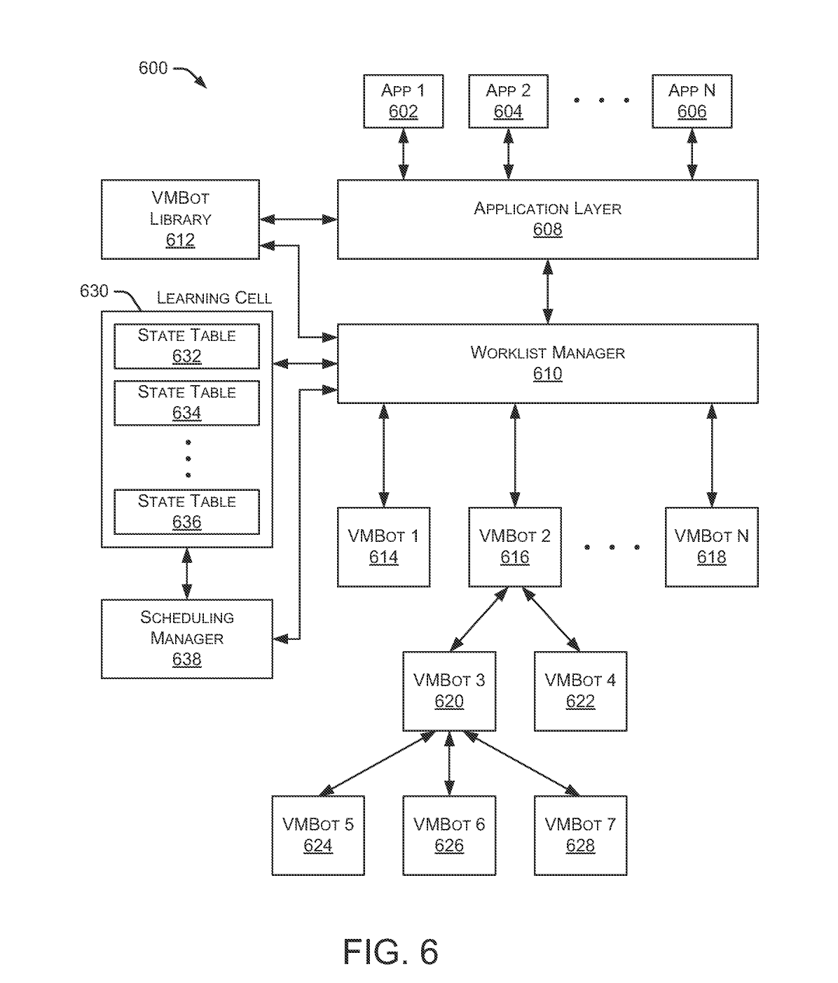

FIG. 6 is a block diagram depicting an embodiment of a system 600 for processing application program tasks. An application layer 608 communicates with any number of application programs 602, 604, and 606. Application layer 608 also communicates with a worklist manager 610 and a VMBot library 612. VMBot library 612 contains various VMBot definitions used to invoke VMBots to perform various application program tasks. In this example, VMBot library 612 contains multiple VMBot definitions created using JavaScript™, which is a dynamic computer programming language used in a variety of web-based systems. In the example of FIG. 6, each VMBot becomes a “library part” that is linkable into a JavaScript program, which allows a developer to assign tasks in the application program to a particular VMBot for processing. Although particular examples discussed herein utilize JavaScript, alternate embodiments may use any computer programming language to perform similar functions.

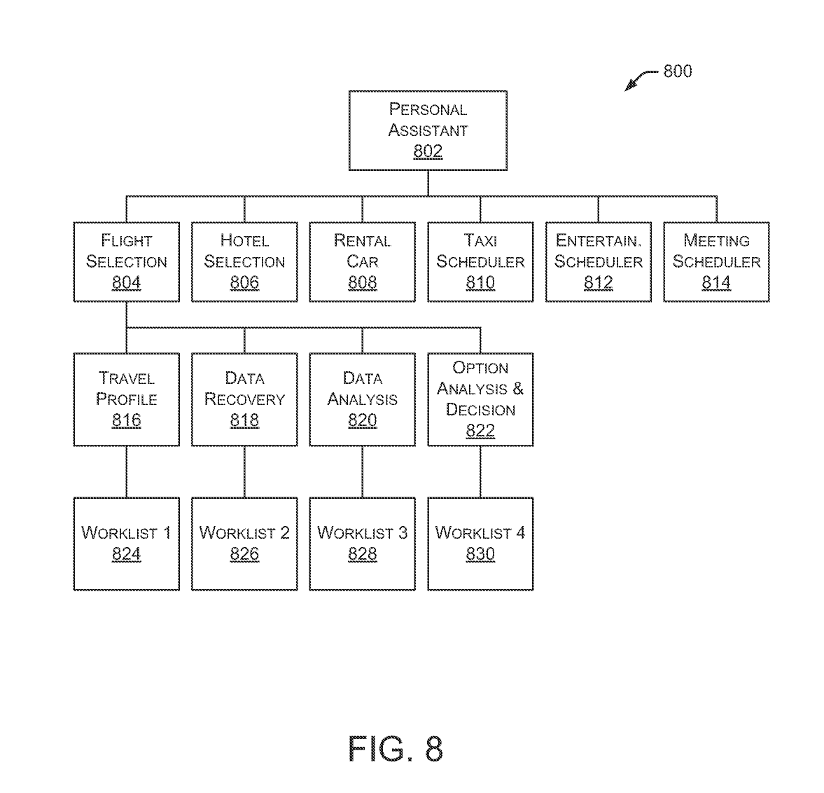

Worklist manager 610 includes one or more worklists, which represent an operational plan and specific details for implementing the operational plan. For example, the operational plan may define an approach to executing an application program using multiple VMBots. Additional details regarding the operational plan are discussed below with respect to FIG. 8. Worklist manager 610 may also include multiple rules and operating parameters associated with the operational plan. These rules and parameters are accessed and applied by the VMBots when performing their assigned tasks. The rules may define how a particular VMBot performs by itself. Other rules may define how the VMBot interacts with other VMBots. As discussed herein, some embodiments use a hierarchy of VMBots to perform multiple tasks associated with an application program.

Worklist manager 610 communicates with applications 602-606 (through application layer 608), JavaScript library 612, and a learning cell 630 to implement the operational plan contained in one or more worklists. Learning cell 630 contains any number of state tables 632, 634, and 636 that store various data representing the current state of different systems, operations, tasks, activities, and the like. In some embodiments, the data contained in state tables 632-636 is used by worklist manager 610 to adjust implementation of the operational plan, such as when an exception occurs. For example, worklist manager 610 may apply one or more rules to the data in state tables 632-636 to determine what action to take (or determine that no action is currently necessary). Learning cell 630 is coupled to a scheduling manager 638, which assists with the scheduling of various tasks and other activities. Scheduling manager 638 is also coupled to worklist manager 610. For example, scheduling manager 638 may determine a particular order for performing multiple tasks, especially when one task relies on the results of a preceding task. Basic scheduling functions, such as ordering of operations, are passed down to other VMBots or managed by worklist manager 610. Additionally, scheduling manager 638 may receive inputs from learning cell 630 based on decisions made by learning cell 630. For example, learning cell 630 may select a particular operation based on data received from a data analysis of other VMBots. This particular operation may then need to be triggered at a particular time relative to other operations in the schedule.

As shown in FIG. 6, system 600 includes a hierarchy of VMBots to perform multiple tasks associated with an application program. In system 600, VMBots 614, 616, and 618 are coupled to worklist manager 610 and represent the top level of the VMBot hierarchy. VMBots 620 and 622 represent a second level in the VMBot hierarchy. VMBots 620 and 622 are invoked to perform specific tasks and receive instructions from VMBot 616. Similarly, VMBots 624, 626, and 628 represent a third level in the VMBot hierarchy. VMBots 624, 626, and 628 are invoked to perform certain tasks and receive their instructions from VMBot 620. Thus, a control hierarchy exists among the multiple VMBots 614-628. In some embodiments, the tasks performed at the lower levels of the hierarchy are more detailed (or more refined) than at the higher levels of the hierarchy. In the example of FIG. 6, VMBot 616 (at the highest level of the hierarchy) acts to control other VMBots in the hierarchy and VMBots 624-628 (at the lowest level of the hierarchy) perform more detailed tasks. Although only three hierarchy levels are shown in FIG. 6, alternate embodiments may include any number of hierarchy levels. Further, alternate embodiments may include additional hierarchy levels controlled by VMBots 614 and 618. The VMBot hierarchy is easily expanded (by invoking more VMBots) or contracted (by deactivating VMBots) to meet the current processing requirements.

In some embodiments, one or more blocks are used to create a particular task. For example, a block that reads data from a particular website can be used by multiple users. In this example, only the “cookies” need to be changed based on an alias definition (e.g., set the cookies to be consistent with the other alias parameters and role-based information). As discussed in greater detail below, an alias describes a method of improving user privacy by creating a proxy personality online that is different than the user's true information, thereby preventing websites and others from obtaining profile information associated with the user.

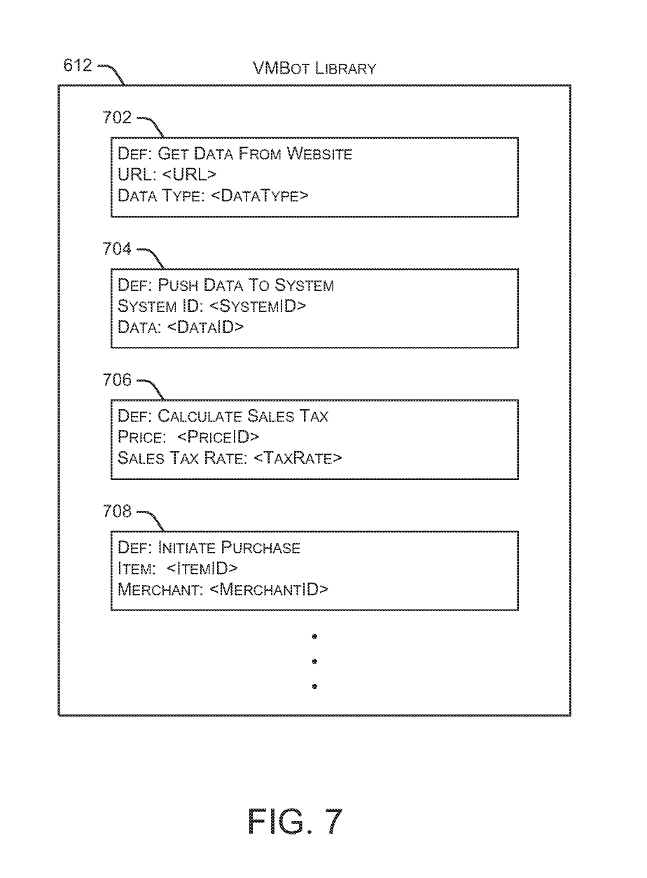

FIG. 7 is a block diagram depicting an embodiment of VMBot library 612. VMBot library 612 contains multiple VMBot definitions. Basic components of a VMBot definition include browser definitions, purchase templates, product templates, worklist entries (e.g., instructions such as “data drop following gather operation” and purchase), authorization information, and one or more URLs. Many different types of VMBots can be defined by the VMBot definitions. For example, these types include transactions, data gathering (e.g., products and web-based information), data processing (e.g., calculations and table-based decisions), decision automation, profile manager, anonymizer segment, emailer, calendar scheduler, and the like.

In some embodiments, VMBot libraries may include one or more of the following components:

a browser,

purchase templates,

product templates,

worklist entries—instructions (e.g., data drop following a gather operation, or purchase item),

authorization, and

URL(s).

In particular embodiments, a VMBot definition includes all six of the components identified above.

VMBot type examples may include one or more of the following data elements to accomplish their tasks:

transactions,

data gathering (products, information on Internet, and the like),

data processing (calculations, table-based decisions, etc.),

decision automation,

profile manager,

anonymizer segment,

emailer,

calendar scheduler,

discount finder,

message generation,

receipt manager,

social network tracker, and

autopurchase scheduler (e.g., Christmas, birthdays, Mother's Day, and the like).

Specific examples of alias definitions (and associated blocks) include the following:

Social network browse (e.g., login to social network and browse the social network to view others' sites),

Social network update (e.g., update photos or comments),

Subscription site browse (e.g., connection login block, different blocks to view information, and sign up for subscription site),

Purchase transaction (e.g., load desired items to purchase into purchase block for specific destination, and a payment block determines how to pay for a specific transaction,

Blog transaction, such as a comment (e.g., blog comment block),

Browse for the purpose of purchase (e.g., network of browse blocks for various possible site visits—user bounces from block-to-block depending on the destination),

Browse anonymously (e.g., similar to “Browse for the purpose of purchase”, but different cookies),

Browse for entertainment (e.g., similar to “Browse for the purpose of purchase”, but includes many more possible sites as destination for browser);

Download software or music (e.g., browse blocks and download blocks), and

Run an online service such as streaming entertainment (e.g., specialized blocks for particular services).

FIG. 8 depicts an example operational plan 800, which includes a set of VMBot tasks that are required to complete a larger operation (also referred to as a “task” or “activity”). Operational plan 800 describes the overall operation and interaction of the multiple VMBots to accomplish the larger operation. Operational plan 800 is written to take advantage of the available VMBot definitions and the tasks available to be performed by the associated VMBots. Operational plan 800 may implement operations that, for example, provide a personal assistant, perform travel planning for a user, or automatically book events for a user, and track company stock data (including the analysis of that data).

Operational plan 800 shown in FIG. 8 is associated with a personal assistant application 802. Personal assistant 802 performs various tasks and activities on behalf of one or more users. For example, personal assistant 802 may perform flight selection tasks 804, hotel selection tasks 806, rental car reservation tasks 808, taxi scheduling tasks 810, entertainment scheduling tasks 812, and meeting scheduling tasks 814. A particular user may perform any number of these tasks 804-814 at a particular time. In some embodiments, each task 804-814 is associated with a particular VMBot and related VMBot definition. Additionally, each task 804-814 may have one or more associated VMBots that perform various sub-tasks. For example, flight selection 804 has associated VMBots that perform sub-tasks related to flight selection. In particular, these sub-tasks manage user profile information 816, retrieve or recover data 818, perform data analysis 820, and perform option analysis and make decisions 822. Further, each sub-task 816-822 has an associated worklist that further defines the specific tasks or activities to be performed by the corresponding sub-task 816-822. As shown in FIG. 8, travel profile 816 has an associated worklist 824, data recovery 818 has an associated worklist 826, data analysis 820 has an associated worklist 828, and option analysis and decision 822 has an associated worklist 830.

Although FIG. 8 only illustrates sub-tasks associated with flight selection task 804, typical embodiments may include any number of worklists, arranged in any number of levels, and associated with any number of different “parent” worklists or tasks. These worklists carry the defining instructions for each VMBot to perform its assigned tasks and operations.

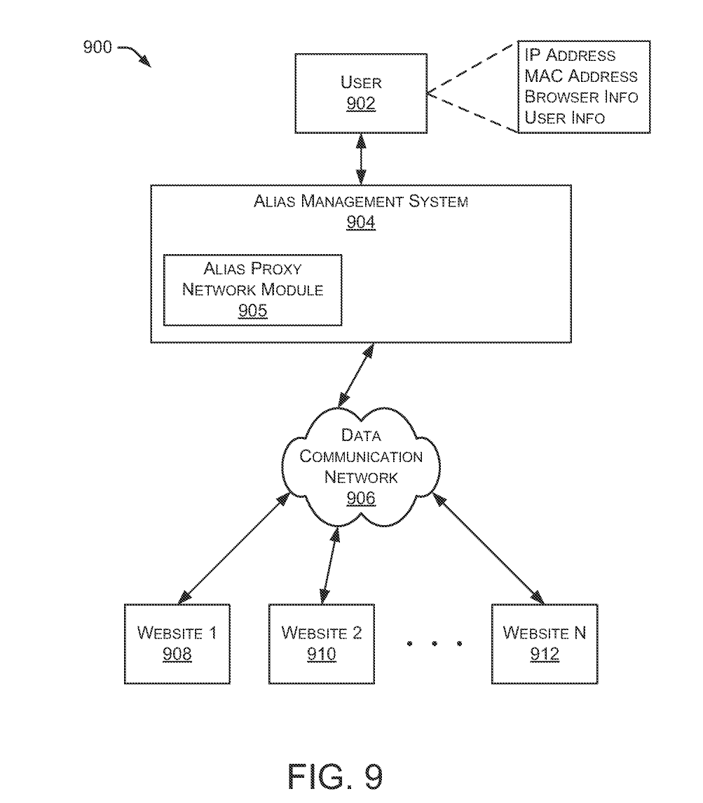

FIG. 9 is a block diagram depicting an environment 900 within which an example embodiment may be implemented. In some embodiments, environment 900 is particularly well-suited to manage and implement various user aliases that offer privacy to the associated user. Environment 900 includes an alias management system 904 accessed by one or more users 902. Each user 902 has an associated IP (Internet Protocol) address, MAC (Media Access Control) address, browser information, user information, and the like. In some embodiments, each user 902 also has associated browser location information, personal information associated with one or more specific tasks, and specific alias names. Alias management system 904 maps a particular user 902 to one or more alias definitions. Each alias associated with the user is implemented using a VMBot, as discussed herein. In some embodiments, certain alias definitions are role-based aliases, such as “a farmer from Kansas”, “a lawyer from New York”, and the like. The alias definition for a role-based alias includes cookies, IP addresses, and other data that are consistent with the alias' role, thereby making the role-based alias more believable.

Alias management system 904 includes an alias proxy network module 905 that interacts with various components in different geographic locations. These components may include hardware, software or a combination of both hardware and software, such that various requests (e.g., website access requests) are routed through the components to maintain the anonymity of the user. Thus, the user is separated from the action or operation they are performing online. Alias proxy network module 905 manages, and coordinates communications with, the various components in any number of different geographic locations.

In some embodiments, each VMBot implements a different alias for a user. In these embodiments, the multiple VMBots only contain information needed to perform a particular task. For example, a specific VMBot may include information necessary to make a purchase at a particular online merchant (merchant name, merchant website, alias login information, etc.) but is unaware of information related to other tasks or other online merchants. Further, the alias information implemented by a VMBot on behalf of a user may be artificial data (i.e., not the user's actual data), such that the VMBot is not exposing any of the user's confidential data to a website. This provides privacy to the user while shopping or performing other activities online, and prevents multiple websites from correlating actual information about the user.

Alias management system 904 communicates with any number of websites 908, 910, and 912 via a data communication network 906. These websites may be ecommerce websites, research websites, service provider websites or any other type of website providing any type of service or information. When user 902 wants to access one of the websites 908-912, alias management system 904 selects an appropriate alias to access the website on the user's behalf instead of the user accessing the website using their actual user data. Alias management system 904 then invokes an appropriate VMBot to implement the selected alias. This use of an alias provides a level of privacy for user 902 and protection of the user's actual data, such as confidential information.

In some embodiments, VMBots are implemented in different geographic locations (e.g., different cities around the country or around the world). By implementing VMBots in different geographic locations, they will have different associated IP addresses and different geolocation data. For example, two different VMBots implementing two different activities for the same user may be located in two different cities. The different geographic locations (and different IP addresses) provide additional privacy to the user by decreasing the likelihood of correlating the two VMBots, or associating either of the VMBots with the actual user. As mentioned above, alias proxy network module 905 assists with the communication between alias manager 904 and the multiple geographic locations.

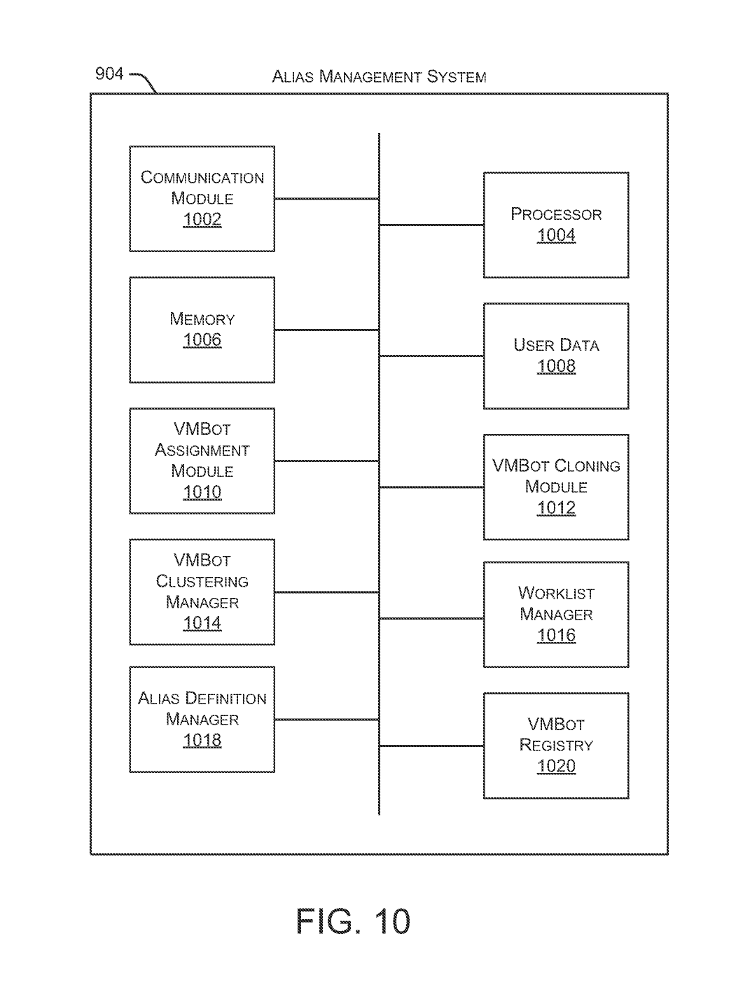

FIG. 10 is a block diagram depicting an embodiment of alias management system 904. As shown in FIG. 10, alias management system 904 includes a communication module 1002, a processor 1004, and a memory 1006. Communication module 1002 allows alias management system 904 to communicate with other systems, such as user 902, data communication network 906, and websites 908, 910, and 912. Processor 1004 executes various instructions to implement the functionality provided by alias management system 904. Memory 1006 stores these instructions as well as other data used by processor 1004 and other modules contained in alias management system 904.

Additionally, alias management system 904 includes user data 1008 that stores various information associated with a particular user. A VMBot assignment module 1010 assigns tasks to appropriate VMBots (implementing one or more aliases) for execution by the assigned VMBot. A VMBot cloning module 1012 creates a new instance of a VMBot by cloning an existing VMBot. VMBot cloning module 1012 is capable of quickly creating a complete copy of an existing VMBot and deploying the newly created VMBot to perform a specific task, such as implementing an alias. VMBot cloning module 1012 also deletes instances of VMBots when they are no longer necessary (e.g., after the VMBot has completed its assigned task).

A VMBot clustering manager 1014 in alias management system 904 handles the clustering of multiple VMBots. Clustering of multiple VMBots allows a specific number of VMBots who share the cluster to communicate with decreased latency and larger transfer rates. For example, a set of VMBots are clustered if they need to share data or communicate together more efficiently than is normally the case for communication between VMBots. In some cases, the processing requirements require VMBots to share data efficiently, while in other cases VMBots need to be geographically distributed and thus are not clustered.

A worklist manager 1016 manages worklists associated with one or more application program tasks or operations. As mentioned herein, a worklist is a set of tasks that need to be performed for a particular process. In some embodiments, multiple VMBots are each responsible for a particular task within the worklist. Worklist manager 1016 manages the assignment of these tasks to VMBots, and manages the performance of the tasks by the assigned VMBot. An alias definition manager 1018 handles the creation and management of various alias definitions used to perform certain processing operations, as discussed herein. A VMBot registry 1020 maintains information about multiple VMBots, such as the task (or alias) that a particular VMBot can perform, a process to which the VMBot is currently assigned, VMBots currently available for assignment, and the like.

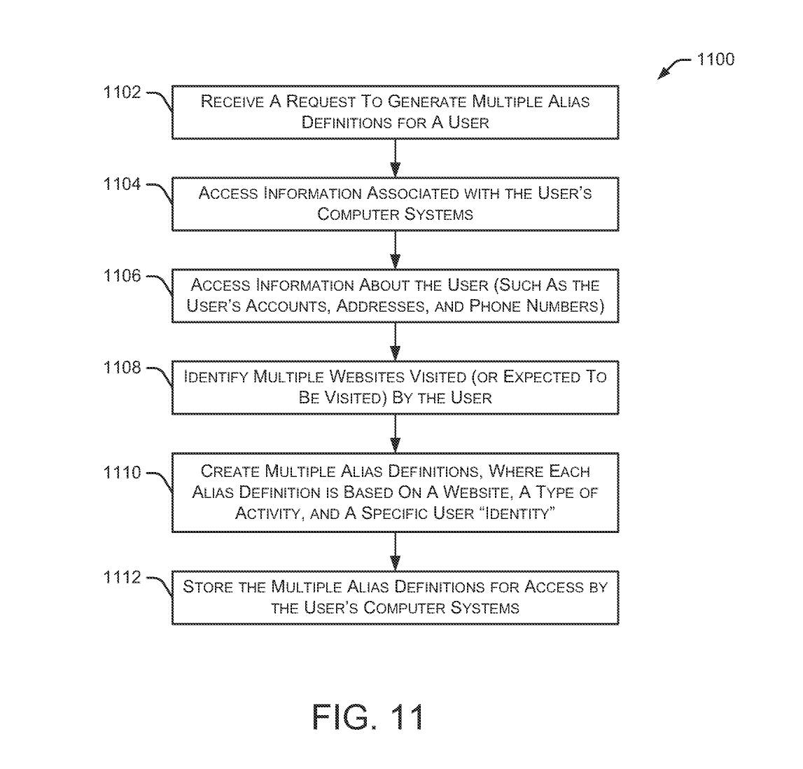

FIG. 11 is a flow diagram depicting an embodiment of a method 1100 for creating alias definitions for a user. Initially, method 1100 receives a request to generate multiple alias definitions for a user at 1102. For example, the different alias definitions may be used for different tasks (e.g., online shopping, online research, and online gaming) or used for different websites (e.g., separate aliases for each online merchant to prevent multiple online merchants from correlating data from the user). Method 1100 then accesses information associated with the user's computer systems (e.g., cookies, IP address, MAC address, and browser type) at 1104. Additionally, information about the user (e.g., user account information, addresses, and phone numbers) is accessed at 1106. Method 1100 further identifies multiple websites visited (or expected to be visited) by the user at 1108. Previously visited websites can be determined based on the user's browser history and other data. The user may provide data regarding sites that they expect to visit in the future.

Method 1100 continues by creating multiple alias definitions at 1110, such that each alias definition is based on a website, at type of activity, and a specific user “identity” or “role.” Finally, the multiple alias definitions are stored at 1112 for access by the user's computer system and other components or systems discussed herein.

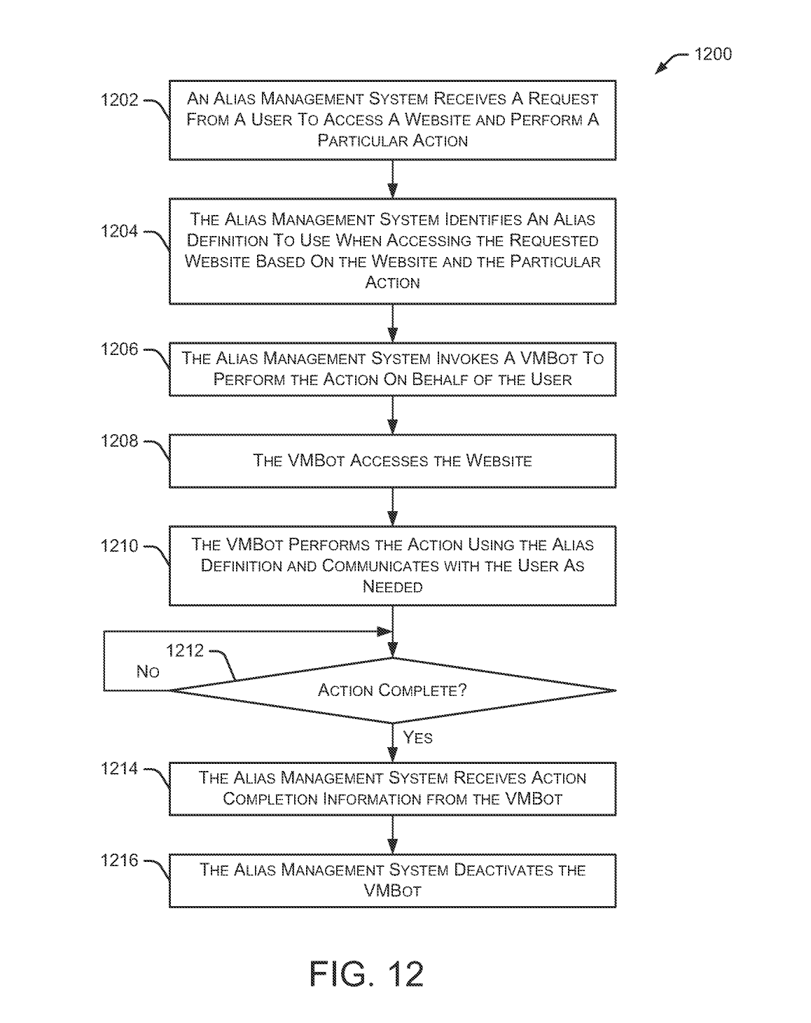

FIG. 12 is a flow diagram depicting an embodiment of a method 1200 for managing performance of user activities with VMBot aliases. Initially, an alias management system receives a request from a user to access a website and perform a particular action at 1202. The alias management system identifies an alias definition to use when accessing the requested website based on the website and the particular action at 1204. The alias management system then invokes a VMBot to perform the action on behalf of the user at 1206. Method 1200 continues as the invoked VMBot accesses the website at 1208 and performs the action using the alias definition at 1210, while communicating with the user as needed.

Additionally, method 1200 monitors the progress of the VMBot to determine whether the action being performed is complete at 1212. If the action is not complete, method 1200 continues to monitor the progress of the VMBot. If the action is complete at 1212, the alias management system receives action completion information from the VMBot at 1214. The action completion information includes, for example, details of the action performed, such as a transaction number or other identifier. Finally, the alias management system deactivates the VMBot at 1216, thereby releasing some of the system resources for use by other VMBots or processes.

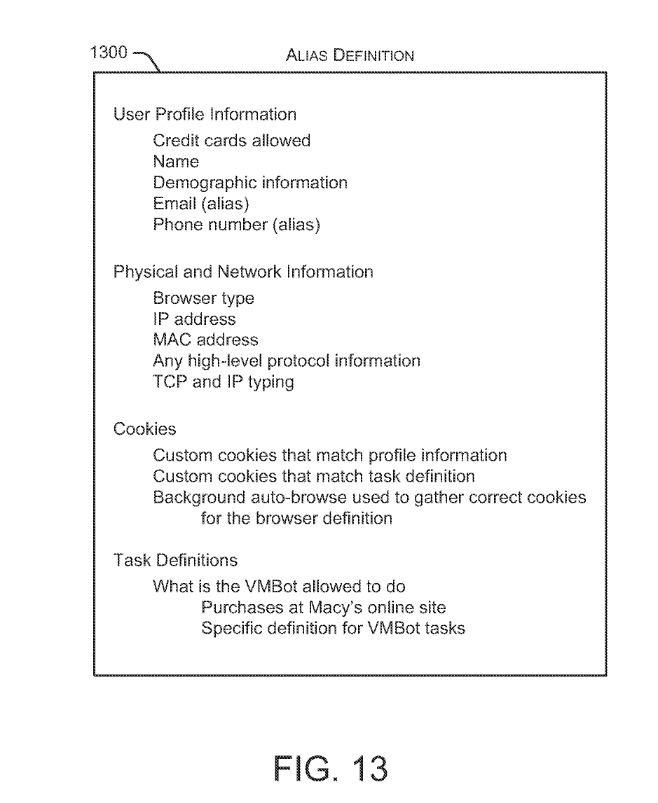

FIG. 13 depicts an example alias definition 1300. In this example, the alias definition includes user profile information, physical and network information, cookie information, and task definitions. For a particular VMBot, specific cookies and user profile information is loaded for purchasing items from a single online merchant. This VMBot is limited to purchasing from the single online merchant and cannot access other websites or perform other activities. Another example VMBot is allowed to browse a list of known URLs, but cannot access other URLs or perform any other tasks. This VMBot is loaded with one or more cookies that are appropriate for its assigned task.

A further VMBot example is limited to posting to a particular forum, and limited to specific types of posts. A social media VMBot example is designed to allow a user to create and manage a social networking account where only specific cookies are seen by the social networking site and the user profile information may be an alias while key personal information is not exposed to the social networking site. Another example VMBot is a news reader that accesses information from specific news sites. In this example, cookies are specifically designed to give the desired user profile to the news sites. Other VMBots are used with online gaming sites and other specialty sites where key information regarding the user is typically accessed by the site. In this situation, the VMBot protects the user's actual information from being accessed by the site and, instead, allows the alias information to be accessed by the site.

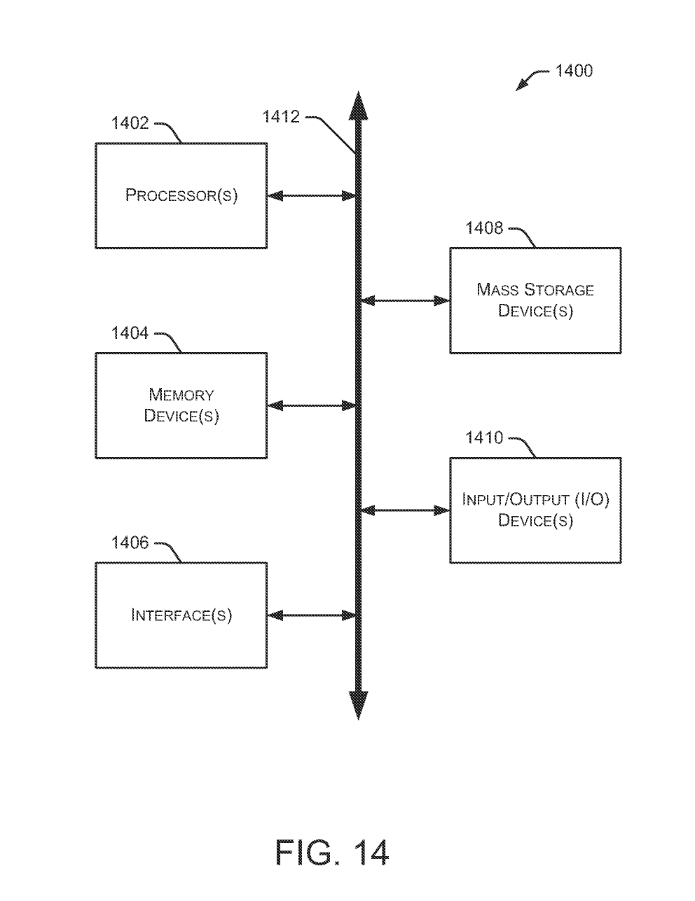

FIG. 14 is a block diagram depicting an example computing device 1400. Computing device 1400 may interface, for example, with a VMBot as if it were another standard computing system. Further, standard computing devices, such as those depicted in FIG. 14, can be configured to hold one or more VMs for use as VMBots. Computing device 1400 may be used to perform various procedures, such as those discussed herein. Computing device 1400 can function as a server, a client or any other computing entity. Computing device 1400 can be any of a wide variety of computing devices, such as a desktop computer, a notebook computer, a server computer, a handheld computer, a tablet, and the like.

Computing device 1400 includes one or more processor(s) 1402, one or more memory device(s) 1404, one or more interface(s) 1406, one or more mass storage device(s) 1408, and one or more Input/Output (I/O) device(s) 1410, all of which are coupled to a bus 1412. Processor(s) 1402 include one or more processors or controllers that execute instructions stored in memory device(s) 1404 and/or mass storage device(s) 1408. Processor(s) 1402 may also include various types of computer-readable media, such as cache memory.

Memory device(s) 1404 include various computer-readable media, such as volatile memory (e.g., random access memory (RAM)) and/or nonvolatile memory (e.g., read-only memory (ROM)). Memory device(s) 1404 may also include rewritable ROM, such as Flash memory.

Mass storage device(s) 1408 include various computer readable media, such as magnetic tapes, magnetic disks, optical disks, solid state memory (e.g., Flash memory), and so forth. Various drives may also be included in mass storage device(s) 1408 to enable reading from and/or writing to the various computer readable media. Mass storage device(s) 1408 include removable media and/or non-removable media.

I/O device(s) 1410 include various devices that allow data and/or other information to be input to or retrieved from computing device 1400. Example I/O device(s) 1410 include cursor control devices, keyboards, keypads, microphones, monitors or other display devices, speakers, printers, network interface cards, modems, lenses, CCDs or other image capture devices, and the like.

Interface(s) 1406 include various interfaces that allow computing device 1400 to interact with other systems, devices, or computing environments. Example interface(s) 1406 include any number of different network interfaces, such as interfaces to local area networks (LANs), wide area networks (WANs), wireless networks, and the Internet.

Bus 1412 allows processor(s) 1402, memory device(s) 1404, interface(s) 1406, mass storage device(s) 1408, and I/O device(s) 1410 to communicate with one another, as well as other devices or components coupled to bus 1412. Bus 1412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1400, and are executed by processor(s) 1402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving, from a user, a request to access a website and perform an action related to the website;
identifying a plurality of alias definitions associated with the user, the plurality of alias definitions describing a plurality of actions related to a plurality of websites;
selecting, using one or more processors, an alias definition based on the action and the website; and
invoking, using the one or more processors, a virtual machine to perform the action on behalf of the user based on alias information contained in the selected alias definition.

2. The method of claim 1, wherein invoking the virtual machine includes cloning an existing virtual machine to create the virtual machine to perform the selected alias definition.

3. The method of claim 1, wherein the virtual machine is selected from a pool of available virtual machines associated with the alias definition.

4. The method of claim 1, wherein the virtual machine is functionally limited to performing a particular task.

5. The method of claim 1, wherein the virtual machine is functionally limited to performing a particular task associated with a particular website.

6. The method of claim 1, wherein the selected alias definition includes at least one of an alias user name, an alias user address, an alias user email address, an alias user phone number, an alias user IP address, an alias user MAC address, a browser type, user credit card information, social media information, an alias user location, and cookies identifying websites visited by the alias user.

7. The method of claim 1, wherein the selected alias definition identifies a specific server to invoke the virtual machine.

8. The method of claim 1, wherein the selected alias definition identifies a geographic location to invoke the virtual machine, and wherein the virtual machine is invoked by a virtual machine in the geographic location.

9. The method of claim 1, wherein each of the plurality of alias definitions describe a different set of user information and user characteristics.

10. The method of claim 1, wherein each of the plurality of alias definitions is associated with a particular role-based alias.

11. The method of claim 1, wherein the method allows the user to access the plurality of websites without revealing the user's personal profile information.

12. The method of claim 1, further comprising deactivating the virtual machine upon completion of the action.

13. A method comprising:
receiving, from a user, a request to access a website and perform an action related to the website;
identifying a plurality of alias definitions associated with the user, the plurality of alias definitions describing a plurality of actions related to a plurality of websites;
selecting, using one or more processors, an alias definition based on the action and the website;
identifying a plurality of tasks associated with the action;
selecting, using the one or more processors, an appropriate virtual machine to perform each of the plurality of tasks associated with the action;
assigning each of the plurality of tasks to the appropriate virtual machine; and
invoking, using one or more processors, the plurality of selected virtual machines to perform the plurality of tasks associated with the action, the plurality of virtual machines operating on behalf of the user based on alias information contained in the selected alias definition.

14. The method of claim 13, further comprising deactivating each of the plurality of virtual machines upon completion of its assigned task.

15. The method of claim 13, wherein the plurality of selected virtual machines are invoked in at least two different geographic locations.

16. The method of claim 13, wherein each of the plurality of selected virtual machines are limited to performing a particular task associated with a particular website.

17. An alias management system comprising:
a memory; and
one or more processors coupled to the memory, the one or more processors configured to:
receive a request to access a website and perform an action related to the website, the request received from a user;
identify a plurality of alias definitions associated with the user, wherein each of the plurality of alias definitions describes at least one action related to at least one website;
select an alias definition based on the requested action and website; and
invoke a virtual machine to perform the action on behalf of the user based on alias information contained in the selected alias definition.

18. The alias management system of claim 17, further comprising an alias proxy module coupled to the one or more processors and configured to interact with a plurality virtual machines in a plurality of different geographic locations.

19. The alias management system of claim 17, further comprising an alias definition manager coupled to the one or more processors and configured to create and manage the plurality of alias definitions associated with the user.

20. The alias management system of claim 17, wherein the virtual machine is functionally limited to performing a particular task associated with the action and the website.
